(19) United States
(12) Patent Application Publication
(10) Pub. No.: US 2022/0414732 A1
(43) Pub. Date: Dec. 29, 2022

(54) SYSTEMS AND METHODS FOR VISUAL IDENTIFIERS

(71) Applicant: Walmart Apollo, LLC, Bentonville, AR (US)

(72) Inventor: Benjamin R. Ellison, San Francisco, CA (US)

(21) Appl. No.: 17/801,508

(22) PCT Filed: Feb. 23, 2021
(86) PCT No.: PCT/US2021/019255

§ 371 Date: Aug. 22, 2022

Related U.S. Application Data
(60) Provisional application No. 62/980,537, filed on Feb. 24, 2020.

(51) Int. Cl. G06Q 30/06

(52) U.S. Cl. CPC G06Q 30/0621; G06Q 30/0643

(57) ABSTRACT

In some embodiments, apparatuses and methods are provided herein useful to a price display system for a product. In some embodiments, a price display system for a product comprises a product display unit, a price sign comprising a substrate upon which markings are applied, wherein the markings include a price for a product and a visual identifier to identify the product, the visual identifier comprising a plurality of markers including a pair of markers, the pair of markers indicate boundaries of the visual identifier, data markers, wherein each of the data markers represents one of two states, wherein the data markers collectively represent an identification number corresponding to the product for sale in the retail environment, and timing markers, wherein each of the timing markers represent one of two states, wherein the timing markers collectively represent a timing value.

### CROSS-REFERENCE TO RELATED APPLICATION

This application claims the benefit of U.S. Provisional Application No. 62/980,537, filed Feb. 24, 2020, which is incorporated by reference in its entirety herein.

### TECHNICAL FIELD

This invention relates generally to visual identifiers and, more particularly, to computer-readable visual identifiers.

### BACKGROUND

Many different types of signs are used to convey information. For example, signs can provide directions, product information, instructions, etc. Signs can be designed to be read by humans and/or machines. For example, a price sign in a retail environment can include text designed to be read by humans and/or machines. Additionally, such signs can include markings that are designed specifically to be read by machines. As one example, such markings can include barcodes or two-dimensional barcodes. While these markings can be used to provide data to a machine, they have drawbacks. For example, traditional barcodes are designed to be read via reflections of laser light and therefore require specialized readers. While two-dimensional barcodes are designed to be readable by non-specialized machines (e.g., smartphones), the distance at which a two-dimensional barcode can be read are quite limited. Accordingly, a need exists for a visual identifier that overcomes these drawbacks.

### BRIEF DESCRIPTION OF THE DRAWINGS

Disclosed herein are embodiments of systems, apparatuses, and methods pertaining to a price display system for a product in a retail environment. This description includes drawings, wherein:

FIG. 1A is a first example of a price sign 100 including a visual identifier 110, according to some embodiments;

FIG. 1B is a second example of a price sign 112 including a visual identifier 114, according to some embodiments;

FIG. 1C depicts a product display unit 122 holding a price sign 120, according to some embodiments;

FIGS. 2A and 2B depict examples of visual identifiers 200, according to some embodiments;

FIG. 3 is a block diagram of a system 300 for providing a price sign, according to some embodiments;

FIG. 4 is a flow chart depicting example operations for providing a price sign, according to some embodiments; and

FIG. 5 depicts an alternative example of a visual identifier 500, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to a price display system for a product in a retail environment. In some embodiments, a price display system for a product in a retail environment comprises a product display unit configured to hold and display products for sale in the retail environment, a price sign comprising a substrate upon which markings are applied and configured to be coupled to a portion of the product display unit, wherein the markings include a price for a product for sale in the retail environment and a visual identifier to identify the product for sale in the retail environment, the visual identifier comprising a plurality of markers in a linear arrangement, wherein the plurality of markers is configured to be optically readable by a device having an optical sensor and including a pair of markers, wherein a first marker of the pair of markers is located on a first side of the plurality of markers and wherein a second marker of the plurality of markers is located on a second side of the plurality of markers, wherein the first marker and the second differ from other markers of the plurality of markers, and wherein each of the first marker and the second marker a greater than one unit in dimension, data markers, wherein each of the data markers represents one of two states, wherein the data markers collectively represent an identification number corresponding the product for sale in the retail environment, and wherein each of the data markers is one unit in dimension, and timing markers, wherein each of the timing markers represent one of two states, wherein the timing markers collectively represent a timing value, and wherein each of the timing markers is one unit in dimension.

Oftentimes, signs are designed with competing interests. First, it is desirable to have a sign that is easily readable and that can be read at a distance. Typically, the larger the sign, the more easily it can be read and the greater the distance at which it can be read. Second, it is typically undesirable to have a sign that is overly large (e.g., a large sign may obstruct the view of something with which the sign is associated). As one example, in a retail environment, it is desirable for a price sign to be easily readable by customers but if the sign is too large, it can obstruct the view of the product for which the price sign is advertising the price. Accordingly, these competing interests must be balanced when creating a sign.

As previously discussed, signs are used to convey information to humans and/or machines. While a sign that is readable by both humans and machines can reduce or eliminate the need for duplicative signs, the competing interests noted above must be considered. For example, a computer-readable identifier on a sign will require space that then cannot be used for human-readable text. While it may seem that the solution is to include a computer-readable identifier that does not require space on the sign, this also has drawbacks. For example, if radio frequency identification (RFID) tags are used on signs, a specialized reader (e.g., an RFID reader) is required to read this data by machine. Alternatively, a computer-readable identifier can be included on the sign that is optically readable. While this can be done in a manner that does not require specialized equipment to read the computer-readable identifier, the computer-readable identifier requires space on the sign that could otherwise be used for human-readable text and/or omitted from the sign. For example, two-dimensional barcodes are designed to be read without specialized equipment (e.g., smartphones). However, most two-dimensional barcodes are designed to be read at short distances (e.g., less than 30 cm). This is problematic if it is desired to read the computer-readable identifier at a greater distance (e.g., two to five meters). While it is possible to create a two-dimensional barcode that can be read at a greater distance, such a two-dimensional barcode must be quite large. Returning to our competing interests, this is problematic because the sign must also be quite large and/or include little space for human-readable text. Disclosed herein are systems, methods, and apparatuses associated with visual identifiers, as well as visual identifiers, that seek to minimize, if not eliminate, some of these drawbacks of traditional identifiers.

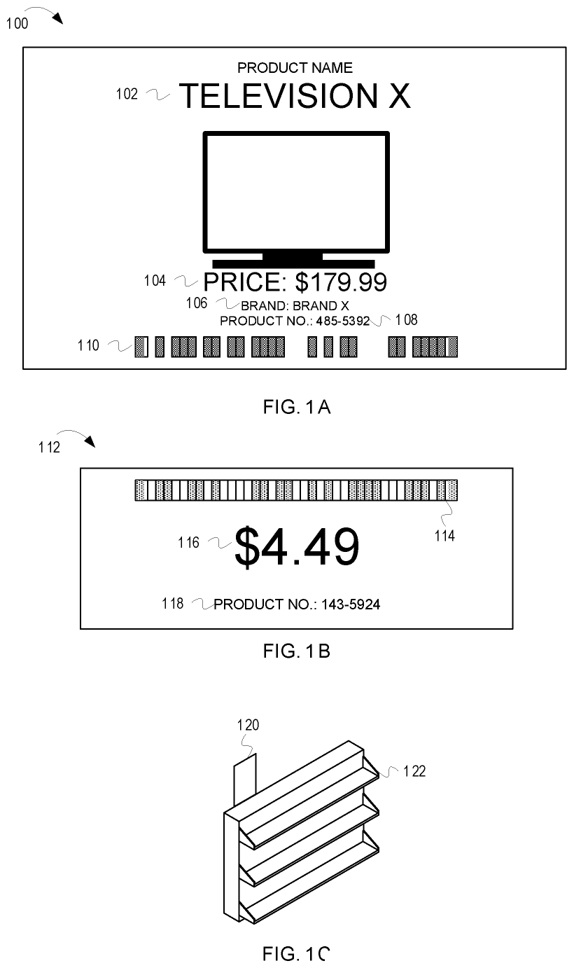

In one embodiment, a visual identifier is disclosed that includes a plurality of markers positioned in a linear arrangement. In such embodiments, the visual identifier can be included on a sign (e.g., a price sign) and read at a distance of several meters without requiring significant space on the sign (i.e., requiring less space than required for traditional computer-readable identifiers). The visual identifier includes a plurality of markings. For example, the markings can be rectangular in shape to enhance readability by machine. The markings can indicate any desired information, such as an identification number (e.g., a product identifier), timing information, price information, etc. The discussion of FIGS. 1A and 1B provides an overview of such a visual identifier.

FIG. 1A is a first example of a price sign 100 including a visual identifier 110, according to some embodiments. Though the examples depicted in FIGS. 1A and 1B include price signs, embodiments, are not so limited. For example, visual identifiers, as described herein, can be incorporated with any signs, labels, tags, etc. as desired in a retail environment. Further, the visual identifiers described herein are not limited to use in retail environments. Rather, such visual identifiers can be used in any environment in which computer-readable identifiers are desired.

The example price sign 100 depicted in FIG. 1A includes multiple fields. These fields are provided by way of example, not limitation, and a price sign can include greater, fewer, and/or different fields than those included on the example price sign 100 in FIG. 1A. As depicted in FIG. 1A, the fields include a product name field 102, product price field 104, product brand field 106, and product number field 108. The product name field 102 includes the name and/or a description of the product with which the price sign 100 is associated. In the example of FIG. 1A, the price sign is for a television, as indicated by the image of the television on the price sign 100 and the name of the television (i.e., Television X) in the product name field 102. The product price field 104 includes a price for the product. The product brand field 106 includes a brand, manufacturer, etc. of the product (i.e., Brand X in FIG. 1A). The product number field 108 an identification number for the product, such as a product identifier, a stockkeeping unit (SKU) number, etc.

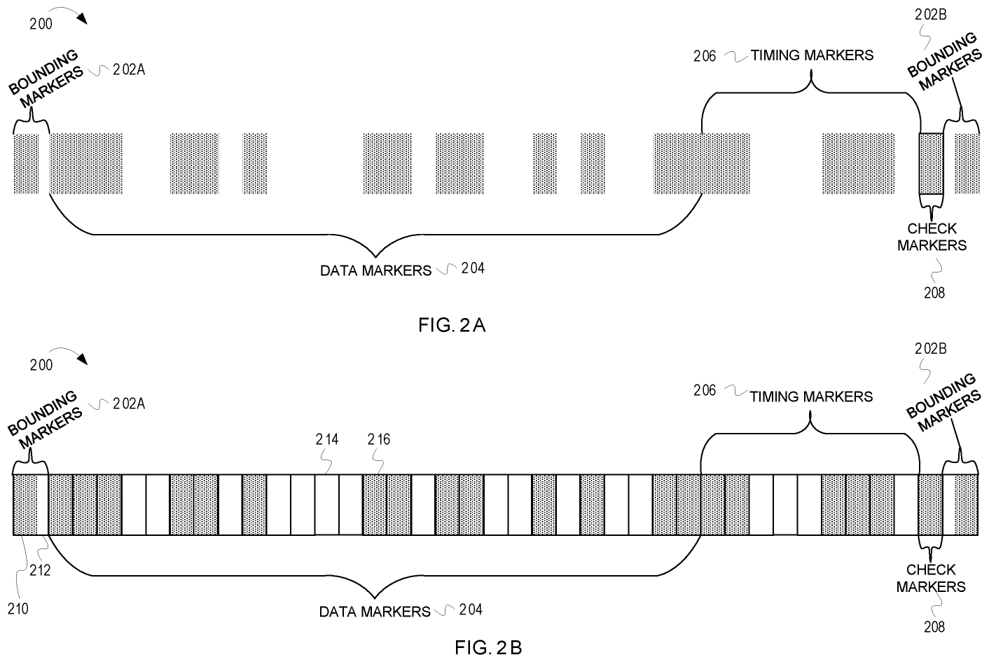

Additionally, the price sign 100 includes the visual identifier 110. The visual identifier includes a number of markings (described in more detail with respect to FIGS. 2A and 2B). The plurality of marking is configured to be read optically, for example, by a user device. The user device can be of any suitable type and includes an optical sensor (e.g., a camera). For example, the device can be one that is dedicated to reading visual identifiers (e.g., a device specific to a retail environment) or a general purpose device, such as a smartphone, tablet, personal digital assistance, smartwatch, etc. In some embodiments, the device is a handheld user device in that the device is sized to be carried by a person (e.g., an employee of a retail facility). The visual identifier 110 can be included on the price sign 100 in any suitable location. For example, as depicted in FIG. 1A, the visual identifier 110 is arranged along a linear edge of the price sign 100.

The price sign 100 can be of any suitable type. The price sign 100 comprises a substrate upon which the fields are presented. For example, the price sign 100 depicted in FIG. 1A is a traditional paper sign (i.e., the substrate is paper). Accordingly, the data in the fields, as well as the visual identifier 110, are printed on the substrate. The data and the visual identifier 110 can be printed on the paper in any suitable manner. In one embodiment, the price sign 100 is configured to be coupled to a product display unit (e.g., a shelving structure, hanging rack, pallet, etc.). For example, FIG. 1C depicts a product display unit 122 holding a price sign 120 (e.g., such as the price sign 110 in FIG. 1A or the price sign 112 in FIG. 1B). As depicted in FIG. 1C, the product display unit 122 is a shelving structure. The price sign 100 can be coupled to a product display unit by adhering the price sign 100 to the product display unit (e.g., with an adhesive such as tape or glue), affixing the price sign 100 to the product display unit (e.g., with a fastener such as a tack or nail), clipping the price sign 100 to the product display unit (e.g., with clips), etc.

Like FIG. 1A, FIG. 1B also depicts a price sign 112. FIG. 1B is a second example of a price sign 112 including a visual identifier 114, according to some embodiments. The price sign 112 depicted in FIG. 1B is incorporated onto an electronic shelf label (ESL). That is, the ESL is configured to present information relating to a product. The ESL can include any number of desired fields and any desired content in the fields. The ESL depicted in FIG. 1B includes a price field 116 and a product number field 118. Additionally, the ESL includes the visual identifier 114.

While the discussion of FIGS. 1A-1C provides an overview of visual identifiers and price signs, the discussion of FIGS. 2A and 2B provide additional information regarding visual identifiers.

FIGS. 2A and 2B depict examples of visual identifiers 200, according to some embodiments. The visual identifiers 200 depicted in FIGS. 2A and 2B both include a plurality of markers. In the embodiment depicted in FIGS. 2A and 2B, the markers represent one of two states (e.g., “on” and “off,” “0” and “1,” etc.). By way of example, in FIGS. 2A and 2B, the two states are depicted as including color and/or markings 214 (e.g., shading, black, etc.) and lacking color and/or markings 216 (e.g., empty). In one embodiment, as depicted in FIG. 2A, the markers do not have individual boundaries. In another embodiment, by contrast as depicted in FIG. 2B, the markers include individual boundaries. Though the markers can be of any desired shape (e.g., round, triangular, etc.), as depicted in FIGS. 2A and 2B, the markers are rectangular. The markers are used to represent (e.g., encode) information.

The markers, and therefore the visual identifiers 200, can be of any suitable size. For example, the markers, and thus the visual identifiers 200, can be sized based on a desired read distance (e.g., 1 meter, 3 meters, 5 meters, 10 meters, etc.). Additionally, or alternatively, the markers, and thus the visual identifier, can be sized based on the dimensions of the sign. For example, if a standard US Letter size sheet of paper (i.e., 8½ inches by 11 inches) is divided to make prices signs that are each roughly 3 inches by 4 inches, the width of the price sign (i.e., 4 inches) can be divided by the number of markers to determine the dimension of the markers. In this example, each marker would be roughly 0.22 inches in width.

Though the markers can be arranged, and grouped, into any desired manner, the visual identifiers 200 depicted in FIGS. 2A and 2B include four groups of markings (i.e., bounding markers (identified by reference numerals 202A and 202B), data markers 204, timing markers 206, and check markers 208). That is, a visual identifier can be configured to include all, or a portion, of the markers described herein and/or different types of markers than described herein (e.g., markers representing different types of data).

The bounding markers indicate the boundaries of the visual identifier 200. For example, the device used to read the visual identifier 200 can determine the boundaries of the visual identifier based on the bounding markers (e.g., where the visual identifier 200 begins or ends, a top of bottom of the visual identifier 200, etc.). In one embodiment, as depicted in FIGS. 2A and 2B, the bounding markers include a pair of markers: 1) a first marker 202A and 2) a second marker 202B. The first marker 202A is located on a first side of the visual identifier 200 (e.g., the beginning of the visual identifier 200). The second marker 202B is located on a second side of the visual identifier 200 (e.g., at the end of the visual identifier 200). Though the example visual identifiers 200 depicted in FIGS. 2A and 2B includes two bounding markers, embodiments are not so limited. For example, in one embodiment, the visual identifier 200 may include only one bounding marker (e.g., at the beginning or end of the visual identifier 200) or include more than two bounding markers (e.g., one for the top and/or bottom of the visual identifier 200). In one embodiment, the bounding markers have set characteristics. In such embodiments, these set characteristics may define the markers as bounding markers, make the bounding markers more easily identifiable, and/or indicate that the markings to follow, or precede, are part of the visual identifier 200. For example, the bounding markers may be sized differently than the other markers (e.g., be larger, smaller, etc. than the other markers), be shaped differently than the other markers, have a specific on/off pattern, etc. As depicted in the example visual identifiers 200 in FIGS. 2A and 2B, the bounding markers are one and half times the size of the other markers (e.g., one and half units in dimension while the other markers are one unit in dimension) and have an area the size of one dimension that is “on” (e.g., filled or colored) and an area the size of one half dimension that is “off” (e.g., empty or lacking color).

The data markers 204 collectively represent an identification number. For example, the data markers 204 can collectively represent an identification number corresponding to a product with which a price sign is associated. Accordingly, the identification number can be of any suitable type (e.g., a product number, a SKU number, etc.). In one embodiment, the data markers 204 encode the identification number, for example, in a binary manner. That is, the data markers each have one of two states. Accordingly, the data markers 204 can include any desired number of markers to, for example, account for all possible identification numbers. In one embodiment, the data markers 204 include thirty markers. Further, in some embodiments, the data markers 204 can be distinguished from the bounding markers and/or other types of markers. The data markers 204 can be distinguished from the bounding markers and/or other types of markers based on their shape, color, placement, size, etc. For example, as previously discussed, in one embodiment, the bounding markers can be one and half units in dimension and each of the data markers 204 can be one unit in dimension.

The timing markers 206 collectively represent a timing value. For example, the timing markers 206 can collectively represent a timing value corresponding to the price sign and/or a product with which the price sign is associated. The timing value can correspond to the price sign, for example, by representing a date upon which the price sign was printed, a date upon which the price sign is no longer valid or should be replaced, a time period for which the price sign is valid, etc. The timing value can correspond to the product with which the price sign is associated, for example, by representing a sell by date for the product, an expiration date for the product, date upon which the product was received, a time period for a promotion associated with the product, a date upon which the product should be moved to another location, etc. The timing markers 206 can include any desired number of markers. In one embodiment, the timing markers include seven markers. Further, in some embodiments, the timing markers 206 can be distinguished from the bounding markers and/or other types of markers. The timing markers 206 can be distinguished from the bounding markers and/or other types of markers based on their shape, color, placement, size, etc. For example, as previously discussed, in one embodiment, the bounding markers can be one and half units in dimension and each of the timing markers 206 can be one unit in dimension.

The check markers 208 are used to verify the authenticity and/or accuracy of the visual identifier 200. For example, the check markers 208 can correspond to a value derived from some, or all, of the other markers. Accordingly, the authenticity and/or accuracy of the visual identifier 200 can be verified via the check markers 208. In one embodiment, the check markers 208 indicate a sum of the data markers 204 and the timing markers 206. As one example, if the sum of the data markers 204 and the timing markers is even, the check markers 208 can be “on” and if the sum of the data markers 204 and the timing markers 206 is odd, the check markers 208 can be “off.” That is, if the markers are represented as ones and zeroes, the value of the check markers 208 can be based on the sum of the ones and zeroes. Additionally, though referred to as check markers 208 in the plural, the check markers 208 may include only a single marker. Further, in some embodiments, the check markers 208 can be distinguished from the bounding markers and/or other types of markers. The check markers 208 can be distinguished from the bounding markers and/or other types of markers based on their shape, color, placement, size, etc. For example, as previously discussed, in one embodiment, the bounding markers can be one and half units in dimension and each of the check markers 208 can be one unit in dimension.

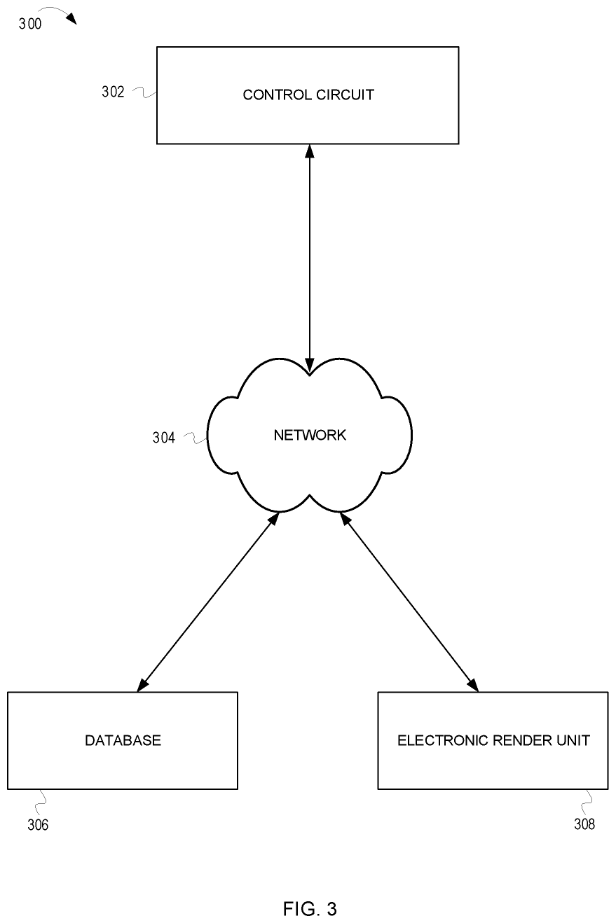

While the discussion of FIGS. 2A and 2B provide additional detail regarding visual identifiers, the discussion of FIG. 3 provides additional detail regarding a system for providing a price sign including a visual identifier.

FIG. 3 is a block diagram of a system 300 for providing a price sign, according to some embodiments. The price sign includes the visual identifier, as described herein. The system 300 includes a control circuit 302, a network 304, a database 306, and an electronic render unit 308. At least some of the control circuit 302, database 306, and electronic render unit 308 are communicatively coupled via the network 304. Accordingly, the network 304 can take any suitable form. For example, the network 304 can include a local area network (LAN) and/or a wide area network (WAN), such as the Internet, and include wired and/or wireless links.

The database 306 is configured to store product identification data. The product identification data can include any desired information about products, such as prices for products, identification numbers for products, timing information for products (e.g., sell by dates, expiration dates, receipt dates, dates based on the seasonality of products, promotional dates, etc.), etc. Additionally, in some embodiments, the database 306 can be configured to store price sign information (e.g., print dates for price signs, validity dates for price signs, etc.).

The control circuit 302 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 302 is configured (for example, by using corresponding programming as will be well understood by those skilled in the art) to carry out one or more of the steps, actions, and/or functions described herein.

By one optional approach the control circuit 302 operably couples to a memory. The memory may be integral to the control circuit 302 or can be physically discrete (in whole or in part) from the control circuit 302 as desired. This memory can also be local with respect to the control circuit 302 (where, for example, both share a common circuit board, chassis, power supply, and/or housing) or can be partially or wholly remote with respect to the control circuit 302 (where, for example, the memory is physically located in another facility, metropolitan area, or even country as compared to the control circuit 302).

This memory can serve, for example, to non-transitorily store the computer instructions that, when executed by the control circuit 302, cause the control circuit 302 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 302 generally generates the data for the price sign. For example, in one embodiment, the control circuit 302 encodes product identification data into display content for the price sign. The control circuit 302 accesses the database to retrieve the product information data for a desired product. The control circuit 302 then encodes the product identification data into display content. The display content can include all of the content for the price sign. Alternatively, the display content may include only the content for the visual identifier. The control circuit 302 transmits the display content to the electronic render unit 308.

The electronic render unit 308 receives the display content from the control circuit 302 and renders the price sign. For example, the electronic render unit can render the price sign by printing the price sign, causing an electronic device (e.g., an ESL) to present the price sign, etc. Accordingly, the electronic render unit 308 can take any suitable form. For example, in the case of a printed price sign, the electronic render unit 308 can be a printer, such as a laser printer. In the case of an ESL, where the substrate of the price sign is the ESL, the electronic render unit 308 can be a computer that transmits data to the ESL. The electronic render unit can render the entire price sign or portions of the price sign. For example, in one embodiment, the electronic render unit 308 renders the visual identifier for an existing, or yet to be generated, price sign.

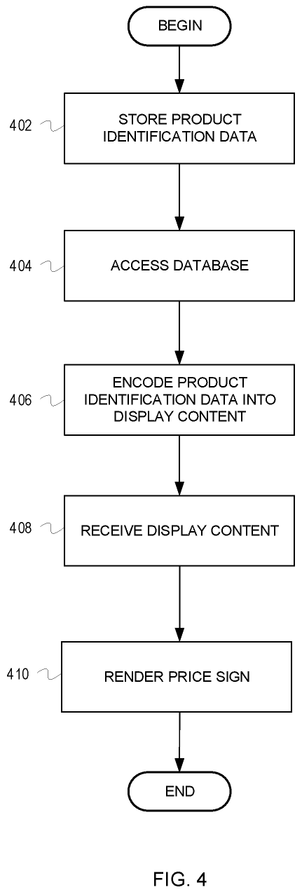

While the discussion of FIG. 3 provides additional detail regarding a system for providing a price sign, the discussion of FIG. 4 provides additional detail regarding providing a price sign.

FIG. 4 is a flow chart depicting example operations for providing a price sign, according to some embodiments. The flow begins at block 402.

At block 402, product identification data is stored. For example, a database can store the product identification data. The product identification data can include any desired information about products, such as prices for products, identification numbers for products, timing information for products (e.g., sell by dates, expiration dates, receipt dates, dates based on the seasonality of products, promotional dates, etc.), etc. Additionally, in some embodiments, the database 306 can be configured to store price sign information (e.g., print dates for price signs, validity dates for price signs, etc.). The flow continues at block 404.

At block 404, the database is accessed. For example, a control circuit can access the database. The control circuit access the database to retrieve product identification data. For example, the control circuit can access the database to retrieve product identification data for a product for which a price sign is to be generated. The flow continues at block 406.

At block 406, product identification data is encoded into display content. For example, the control circuit can encode the product identification data into display content. The control circuit encodes the product identification data into display content by, for example, converting the product identification data into a format that is recognizable by an electronic render unit and/or price sign. For example, if the electronic render unit is a printer, the control circuit can encode the product identification data into display content by converting the product identification data into a printer control language (PCL) file. As another example, if the price sign is an ESL, the control circuit can encode the product identification information into display content based on requirements of the ESL (e.g., data file types, data structures, control languages, etc.). In some embodiments, the display content includes the all of the content for the price sign. Additionally, the display content can include parameters of the price sign, such as sizes, margins, etc. Alternatively, the display content may include only a portion of the content for the price sign. For example, in one embodiment, the display content includes only the visual identifier. The flow continues at block 408.

At block 408, the display content is received. For example, the electronic render device can receive the display content from the control circuit. In one embodiment, control circuit transmits the display content to the electronic render unit via a network, as described previously. The flow continues at block 410.

At block 410, the price sign is rendered. For example, the electronic render unit can render the price sign. If the price sign is to be rendered on a printable substrate, the electronic render unit can render the price sign by printing the price sign, or a portion of the price sign, on the substrate. If the price sign is to be rendered on an electronic substrate, the electronic render unit can render the price sign by transmitted the display content to the electronic substrate or otherwise programming the electronic price sign with the display content.

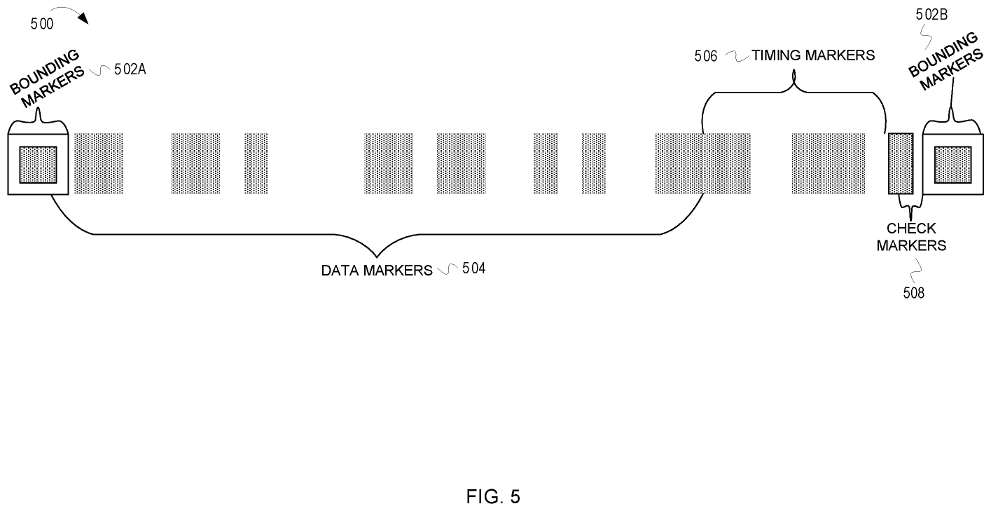

While FIGS. 1-2 depict visual identifiers with a first style of bounding markers, FIG. 5 depicts a visual identifier with a second style of bounding marker.

FIG. 5 depicts an alternative example of a visual identifier 500, according to some embodiments. Like the visual identifiers depicted previously, the visual identifier 500 depicted in FIG. 5A includes a plurality of markers. In the embodiment depicted in FIG. 5, the markers represent one of two states (e.g., “on” and “off,” “0” and “1,” etc.). As one example, and depicted in FIG. 5, the two states are depicted as including color and/or markings (e.g., shaded, black, etc.) and lacking color and/or markings (e.g., empty). Though the markers can be of any desired shape (e.g., round, triangular, etc.), as depicted in FIG. 5, the markers are rectangular. The markers are used to represent (e.g., encode) information.

The markers, and therefore the visual identifier 500, can be of any suitable size. For example, the markers, and thus the visual identifier 500, can be sized based on a desired read distance (e.g., 1 meter, 3 meters, 5 meters, 10 meters, etc.). Additionally, or alternatively, the markers, and thus the visual identifier 500, can be sized based on the dimensions of the sign. For example, if a standard US Letter size sheet of paper (i.e., 8½ inches by 11 inches) is divided to make prices signs that are each roughly 3 inches by 4 inches, the width of the price sign (i.e., 4 inches) can be divided by the number of markers to determine the dimension of the markers. In this example, each marker would be roughly 0.22 inches in width.

Though the markers can be arranged, and grouped, into any desired manner, the visual identifier 500 depicted in FIG. 5 includes four groups of markings (i.e., bounding markers (identified by reference numerals 502A and 502B), data markers 504, timing markers 506, and check markers 508). That is, a visual identifier 500 can be configured to include all, or a portion, of the markers described herein and/or different types of markers than described herein (e.g., markers representing different types of data).

The bounding markers indicate the boundaries of the visual identifier 500. For example, the device used to read the visual identifier 500 can determine the boundaries of the visual identifier based on the bounding markers (e.g., where the visual identifier 500 begins or ends, a top of bottom of the visual identifier 500, etc.). In one embodiment, as depicted in FIG. 5, the bounding markers include a pair of markers: 1) a first marker 502A and 2) a second marker 502B. The first marker 502A is located on a first side of the visual identifier 500 (e.g., the beginning of the visual identifier 500). The second marker 502B is located on a second side of the visual identifier 500 (e.g., at the end of the visual identifier 500). Though the example visual identifier 500 depicted in FIG. 5 includes two bounding markers, embodiments are not so limited. For example, in one embodiment, the visual identifier 500 may include only one bounding marker (e.g., at the beginning or end of the visual identifier 500) or include more than two bounding markers (e.g., one for the top and/or bottom of the visual identifier 500). In one embodiment, the bounding markers have set characteristics. In such embodiments, these set characteristics may define the markers as bounding markers, make the bounding markers more easily identifiable, and/or indicate that the markings to follow, or precede, are part of the visual identifier 500. For example, the bounding markers may be sized differently than the other markers (e.g., be larger, smaller, etc. than the other markers), be shaped differently than the other markers, have a specific on/off pattern, etc. As depicted in FIG. 5, the bounding markers include a contour within a contour. Specifically, the bounding markers include a box within a box, as depicted in FIG. 5. Additionally, though depicted in various ways herein, the bounding markers can take any suitable shape, color, size, pattern, etc.

The data markers 504 collectively represent an identification number. For example, the data markers 504 can collectively represent an identification number corresponding to a product with which a price sign is associated. Accordingly, the identification number can be of any suitable type (e.g., a product number, a SKU number, etc.). In one embodiment, the data markers 504 encode the identification number, for example, in a binary manner. That is, the data markers each have one of two states. Accordingly, the data markers 504 can include any desired number of markers to, for example, account for all possible identification numbers. In one embodiment, the data markers 504 include thirty markers. Further, in some embodiments, the data markers 504 can be distinguished from the bounding markers and/or other types of markers. The data markers 504 can be distinguished from the bounding markers and/or other types of markers based on their shape, color, placement, size, etc. For example, as previously discussed, in one embodiment, the bounding markers can include a contour within a contour and each of the data markers 504 can be one unit in dimension.

The timing markers 506 collectively represent a timing value. For example, the timing markers 506 can collectively represent a timing value corresponding to the price sign and/or a product with which the price sign is associated. The timing value can correspond to the price sign, for example, by representing a date upon which the price sign was printed, a date upon which the price sign is no longer valid or should be replaced, a time period for which the price sign is valid, etc. The timing value can correspond to the product with which the price sign is associated, for example, by representing a sell by date for the product, an expiration date for the product, date upon which the product was received, a time period for a promotion associated with the product, a date upon which the product should be moved to another location, etc. The timing markers 506 can include any desired number of markers. In one embodiment, the timing markers include seven markers. Further, in some embodiments, the timing markers 506 can be distinguished from the bounding markers and/or other types of markers. The timing markers 506 can be distinguished from the bounding markers and/or other types of markers based on their shape, color, placement, size, etc. For example, as previously discussed, in one embodiment, the bounding markers can include a contour within a contour and each of the timing markers 506 can be one unit in dimension.

The check markers 508 are used to verify the authenticity and/or accuracy of the visual identifier 500. For example, the check markers 508 can correspond to a value derived from some, or all, of the other markers. Accordingly, the authenticity and/or accuracy of the visual identifier 500 can be verified via the check markers 508. In one embodiment, the check markers 508 indicate a sum of the data markers 504 and the timing markers 506. As one example, if the sum of the data markers 504 and the timing markers is even, the check markers 508 can be “on” and if the sum of the data markers 504 and the timing markers 506 is odd, the check markers 508 can be “off.” That is, if the markers are represented as ones and zeroes, the value of the check markers 508 can be based on the sum of the ones and zeroes. Additionally, though referred to as check markers 508 in the plural, the check markers 508 may include only a single marker. Further, in some embodiments, the check markers 508 can be distinguished from the bounding markers and/or other types of markers. The check markers 508 can be distinguished from the bounding markers and/or other types of markers based on their shape, color, placement, size, etc. For example, as previously discussed, in one embodiment, the bounding markers can be one and half units in dimension and each of the check markers 508 can be one unit in dimension.

In some embodiments, a price display system for a product in a retail environment comprises a product display unit configured to hold and display products for sale in the retail environment, a price sign comprising a substrate upon which markings are applied and configured to be coupled to a portion of the product display unit, wherein the markings include a price for a product for sale in the retail environment and a visual identifier to identify the product for sale in the retail environment, the visual identifier comprising a plurality of markers in a linear arrangement, wherein the plurality of markers is configured to be optically readable by a device having an optical sensor and including a pair of markers, wherein a first marker of the pair of markers is located on a first side of the plurality of markers and wherein a second marker of the plurality of markers is located on a second side of the plurality of markers, wherein the first marker and the second marker indicate boundaries of the visual identifier, and wherein each of the first marker and the second marker differ from other markers of the plurality of markers, data markers, wherein each of the data markers represents one of two states, wherein the data markers collectively represent an identification number corresponding the product for sale in the retail environment, and wherein each of the data markers is one unit in dimension, and timing markers, wherein each of the timing markers represent one of two states, wherein the timing markers collectively represent a timing value, and wherein each of the timing markers is one unit in dimension.

In some embodiments, a system for providing a price sign comprises a database configured to store product identification data, a control circuit communicatively coupled to the database, wherein the control circuit is configured to access the database and encode the product identification data into display content for the price sign, an electronic render unit communicatively coupled to the control circuit, wherein the electronic render unit is configured to receive, from the control circuit the display content for the price sign and render, in response to receipt of the display content for the price sign, the price sign, wherein the price sign includes a visual identifier comprising a plurality of markers defined by the display content, wherein the plurality of markers includes a pair of markers, wherein a first marker of the pair of markers is located on a first side of the plurality of markers and wherein a second marker of the pair of markers is located on a second side of the plurality of markers, wherein the first marker and the second marker indicate boundaries of the visual identifier, and wherein each of the first marker and the second marker differ from other markers of the plurality of markers, data markers, wherein each of the data markers represents one of two states, wherein the data markers represent an identification number, and wherein each of the data markers is one unit in dimension, and timing markers, wherein each of the timing markers represents one of two state, wherein the timing markers represent a timing value, and wherein each of the timing markers is one unit in dimension.

In some embodiments, a visual identifier to identify a product for sale in a retail environment comprises a plurality of markers in a linear arrangement, wherein the plurality of markers is configured to be optically readable by a device having an optical sensor, and wherein the plurality of markers includes a pair of markers, wherein a first marker of the pair of markers is located on a first side of the plurality of markers and wherein a second marker of the pair of markers is located on a second side of the plurality of markers, wherein the first marker and the second marker indicate boundaries of the visual identifier, and wherein each of the first marker and the second marker differ from other markers of the plurality of markers, data markers, wherein each of the data markers represents an identification number corresponding to a product for sale in the retail environment, and wherein each of the data markers is one unit in dimension, and timing markers, wherein each of the timing markers represents one of two states, wherein the timing markers collectively represent a timing value, and wherein each of the timing markers is one unit in dimension.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A price display system for a product in a retail environment, the price display system comprising:
a product display unit configured to hold and display products for sale in the retail environment;
a price sign comprising a substrate upon which markings are applied and configured to be coupled to a portion of the product display unit, wherein the markings include:
a price for a product for sale in the retail environment; and
a visual identifier to identify the product for sale in the retail environment, the visual identifier comprising:
a plurality of markers in a linear arrangement, wherein the plurality of markers is configured to be optically readable by a device having an optical sensor and including:
a pair of markers, wherein a first marker of the pair of markers is located on a first side of the plurality of markers and wherein a second marker of the pair of markers is located on a second side of the plurality of markers, wherein the first marker and the second marker indicate boundaries of the visual identifier, and wherein each of the first marker and the second marker differ from other markers of the plurality of markers;
data markers, wherein each of the data markers represents one of two states, wherein the data markers collectively represent an identification number corresponding to the product for sale in the retail environment, and wherein each of the data markers is one unit in dimension; and
timing markers, wherein each of the timing markers represent one of two states, wherein the timing markers collectively represent a timing value, and wherein each of the timing markers is one unit in dimension.

2. The price display system of claim 1, wherein the substrate is paper.

3. The price display system of claim 2, wherein the markings are applied via a printer.

4. The price display system of claim 1, wherein each of the plurality of markers is rectangular in shape.

5. The price display system of claim 1, wherein the first marker and the second marker differ from the other markers of the plurality of markers by one of shape, color, size, and pattern.

6. The price display system of claim 1, wherein the plurality of markers includes 40 markers, wherein the data markers include 30 markers, and wherein the timing markers include seven markers.

7. The price display system of claim 1, wherein the timing value is a date associated with the price sign.

8. The price display system of claim 1, wherein the visual identifier further includes a check marker, wherein a value of the check marker is based on a sum of at least a portion of the plurality of markers.

9. A system for providing a price sign, the system comprising:
a database configured to store product identification data;
a control circuit communicatively coupled to the database, wherein the control circuit is configured to:
access the database; and
encode product identification data into display content for the price sign;
an electronic render unit communicatively coupled to the control circuit, wherein the electronic render unit is configured to:
receive, from the control circuit, the display content for the price sign; and
render, in response to receipt of the display content for the price sign, the price sign;
wherein the price sign includes:
a visual identifier, comprising:
a plurality of markers defined by the display content, wherein the plurality of markers includes:
a pair of markers, wherein a first marker of the pair of markers is located on a first side of the plurality of markers and wherein a second marker of the pair of markers is located on a second side of the plurality of markers, wherein the first marker and the second marker indicate boundaries of the visual identifier, and wherein each of the first marker and the second marker differ from other markers of the plurality of markers;
data markers, wherein each of the data markers represents one of two states, wherein the data markers represent an identification number, and wherein each of the data markers is one unit in dimension; and
timing markers, wherein each of the timing markers represents one of two states, wherein the timing markers represent a timing value, and wherein each of the timing markers is one unit in dimension.

10. The system of claim 9, further comprising:
a handheld user device coupled to the database and comprising an optical sensor configured to be optically read the plurality of markers, wherein the handheld user device is configured to determine the identification number and the timing value.

11. The system of claim 9, wherein the electronic render unit comprises a printer.

12. The system of claim 9, wherein the price sign comprises paper.

13. The system of claim 9, wherein the price sign is an electronic shelf label (ESL).

14. The system of claim 9, wherein each of plurality of markers is rectangular in shape.

15. The system of claim 9, wherein the first marker and the second marker differ from the other markers of the plurality of markers by one of shape, color, size, and pattern.

16. The system of claim 9, wherein the plurality of markers includes 40 markers, wherein the data markers include 30 markers, and wherein the timing markers include seven markers.

17. The system of claim 9, wherein the visual identifier further includes a check marker, wherein a value of the check marker is based on a sum of at least a portion of the plurality of markers.

18. The system of claim 9, wherein the price sign is for a product, and wherein the identification number is a product identifier associated with the product and the timing value is a date associated with the price sign.

19. A visual identifier to identify products for sale in a retail environment, the visual identifier comprising:
a plurality of markers in a linear arrangement, wherein the plurality of markers is configured to be optically readable by a device having an optical sensor, and wherein the plurality of markers includes:
a pair of markers, wherein a first marker of the pair of markers is located on a first side of the plurality of markers and wherein a second marker of the pair of markers is located on a second side of the plurality of markers, wherein the first marker and the second marker indicate boundaries of the visual identifier, and wherein each of the first marker differ from other markers of the plurality of markers;
data markers, wherein each of the data markers represents one of two states, wherein the data markers collectively represent an identification number corresponding to a product for sale in the retail environment, and wherein each of the data markers is one unit in dimension; and
timing markers, wherein each of the timing markers represents one of two states, wherein the timing markers collectively represent a timing value, and wherein each of the timing markers is one unit in dimension.

20. The visual identifier of claim 19, wherein the visual identifier is included on a price sign, and wherein the identification number is a product identifier of a product associated with the price sign, and the timing value is a date associated with the price sign, and wherein the linear arrangement is arranged to be rendered along a linear edge of a price sign.
